(19) United States
(12) Patent Application Publication
(10) Pub. No.: US 2025/0333133 A1
(43) Pub. Date: Oct. 30, 2025

(54) Displaceable Bash Guard With Spring

(71) Applicant: Eko Sport, Inc., Grand Junction, CO (US)

(72) Inventors: Scott S. Winans, Grand Junction, CO (US); Noah Sears, Grand Junction, CO (US)

(73) Assignee: Eko Sport, Inc., Grand Junction, CO (US)

(21) Appl. No.: 19/188,753

(22) Filed: Apr. 24, 2025

Related U.S. Application Data
(60) Provisional application No. 63/638,731, filed on Apr. 25, 2024.

(51) Int. Cl. B62J 13/00

(52) U.S. Cl. CPC B62J 13/00

(57) ABSTRACT

A guard assembly for a chain and chain ring includes a bracket and a guard. The bracket and the guard are configured to move relative to one another. The movement is governed by a resilient spring placed to absorb and release impact energy imparted to the guard.

### BACKGROUND OF THE INVENTION

The present disclosure relates generally to parts of a bicycle or other chain-drive style vehicle. More particularly, the present disclosure relates to an improved design of a guard that minimizes impacts to a drive system. Even more particularly, the present disclosure relates to an improved guard, commonly known as a bash guard, that is able to resiliently absorb impacts from obstacles in the environment and minimize the risk of them impacting a front chain ring or a motor on a bicycle.

It is common when riding a bicycle to travel in off-road areas. Bicycles used in those areas are commonly referred to as “mountain bikes,” but may have other names. Some mountain bikes are manually pedaled, some are motor-powered, and some use a combination of drive mechanisms. When these bicycles are driven in off-road areas, they are at risk of encountering obstacles, such as rocks, roots, stumps, and branches, among other things. Riders can, of course, encounter such obstacles in any location. But they are most common in unpaved trail riding.

If a rider is in an area away from a road and encounters an obstacle, the rider risks damage to the bicycle. Some damage, such as scratches or scrapes from branches or rocks, is cosmetic or primarily cosmetic. However, if part of the drive system is damaged, the rider may become stranded and unable to ride the bicycle to a place of safety. Repairing this damage may also be costly if a motor or a mount is damaged.

Current bash guards can be useful for protection. If a bash guard is too resilient, however, the bash guard may allow too much deformation upon encountering a large obstacle. This can risk damage to the rider and the bicycle. If, on the other hand, the bash guard lacks resilience, it may protect the drive system, but it may cause the entire bicycle to be displaced by lifting it from the ground. If the bash guard lacks resilience, but is thinner, it is at risk of shattering on impact, thereby injuring the rider and failing to protect the drive system.

The need therefore exists for a bash guard configuration that incorporates both a resilient element that allows deformation and a less resilient element to minimize the risk of damage to the drive assembly. It may be further desirable to make the configuration tunable to allow a rider to determine the degree of resilience to absorb an appropriate amount of impact. Such a configuration may allow a rider to customize their ride to their desires and provide a more optimized protection for the rider and the drivetrain.

### SUMMARY OF THE INVENTION

In one embodiment, a guard assembly for protecting a portion of a bicycle assembly includes a bracket, a guard and a spring. The bracket may include a first arm and an engagement surface adjacent the first arm. The guard may be adjustably secured to the bracket. The guard may define a cavity. The spring may have a first side configured to fit against the guard, a second side configured to contact the engagement surface, and a rest configuration. The guard may be configured to move relative to the bracket. The relative position of the guard and the bracket may define a deformation of the spring from the rest configuration.

The spring may define a slot. The slot may contact the engagement surface.

The cavity may have at least three lobes. At least a portion of the spring may be configured to pass into the cavity. At least a portion of the first leg may be configured to pass into the cavity.

The bracket may comprise a second arm. The first arm may be attached to the guard by a first fastener and the second arm may be attached to the guard by a second fastener. The guard may move substantially linearly relative to the bracket.

A guard assembly for protecting a portion of a bicycle assembly may include a bracket, a guard, a fastener, and a spring. The bracket may include a first arm. The first arm may define a first slot. The guard may define a first aperture. The fastener may be configured to pass through the first aperture and the first slot to secure the guard to the bracket adjustably along the first slot. The spring may have a first side configured to be in direct contact with the bracket and a second side in contact with the guard.

The bracket may include a second arm defining a second slot. The guard may be configured to move laterally relative to the bracket. The guard may be configured to move rotationally relative to the bracket.

The spring may be configured to fit within a spring cavity defined in one of the guard and the bracket. The first side of the spring may define a slot. The spring may be adjacent the first arm.

A guard assembly for protecting a portion of a bicycle assembly may include a bracket, a guard, and a spring. The bracket may have at least one arm. The guard may define a cavity. The bracket and the guard may be attached to one another by a fastener. The bracket and the guard may be configured to move relative to one another by compressing the spring. The at least one arm may be configured to move within the cavity.

The cavity may have a bottom surface. A free end of the at least one arm may be capable of contacting the bottom surface. The spring may contact the bottom of the cavity. The spring may formed from a resilient material. The spring may define a slot. The slot may contact the bracket. The spring may be spaced from the at least one arm.

### BRIEF DESCRIPTION OF DRAWINGS

FIG. 1 is a perspective view of a bicycle showing the general configuration and position of the guard assembly according to the disclosure;

FIG. 2 is an exploded view of one embodiment of the guard assembly according to the disclosure;

FIG. 3 is a side view of one embodiment of a spring according to the disclosure;

FIG. 4 is a front view of the spring of FIG. 3;

FIG. 5 is a perspective view of the spring of FIG. 3;

FIG. 6 is a cross-sectional view of one embodiment of a guard according to the disclosure taken along line 6-6 of FIG. 2;

FIG. 7 is a back view of one embodiment of the front guard assembly according to the disclosure;

FIG. 8 is a cross-sectional view of the assembly of FIG. 7, taken along line 8-8 of FIG. 7;

FIG. 9 is a rear perspective view of the assembly of FIG. 7;

FIG. 10 is a front and top perspective view of the assembly of FIG. 7;

FIG. 11 is a side view of the assembly of FIG. 7;

FIG. 12 is a side view of the assembly of FIG. 7, showing a side opposite the side view of FIG. 11;

FIG. 13 is a cross-sectional view of the assembly of FIG. 7, taken along line 13-13 of FIG. 11;

FIG. 14 is a side view of an alternative embodiment of a bracket;

FIG. 15 is a side view of another alternative embodiment of a bracket;

FIG. 16 is a cross-sectional view of the assembly of FIG. 11 taken along line 16-16 of FIG. 11;

FIG. 17 is a side view of another embodiment of a spring according to the disclosure;

FIG. 18 is a front view of the spring of FIG. 17;

FIG. 19 is a perspective view of the spring of FIG. 17;

FIG. 20 is a back view of an assembly according to the disclosure incorporating the spring of FIG. 17;

FIG. 21 is a cross-sectional view of the assembly of FIG. 20 taken along line 21-21 of FIG. 20;

FIG. 22 is a cross-sectional view of the assembly of FIG. 21 taken along line 22-22 of FIG. 21;

FIG. 23 is a side view of an alternative embodiment of a guard assembly incorporating an alternative embodiment of a guard;

FIG. 24 is a perspective view of the assembly of FIG. 23;

FIG. 25 is a cross-sectional view of the assembly of FIG. 23 taken along line 25-25 of FIG. 23;

FIG. 26 is a cross-sectional view of an alternative embodiment of the assembly similar to the view of FIG. 8; and

FIG. 27 is a cross-sectional view of yet another alternative embodiment of the assembly similar to the view of FIG. 8.

FIG. 28 is a perspective view of an alternative embodiment of a guard assembly having an alternative embodiment of a bracket;

FIG. 29 is a perspective view of another alternative embodiment of a guard assembly having another alternative embodiment of a bracket;

FIG. 30 is a perspective view of yet another alternative embodiment of a guard assembly having yet another alternative embodiment of a bracket;

FIG. 31 is a perspective view of another alternative embodiment of a spring;

FIG. 32 is a side view of the spring of FIG. 31;

FIG. 33 is a top view of the spring of FIG. 31;

FIG. 34 is a back view of the spring of FIG. 31;

FIG. 35 is a cross-sectional view of the spring of FIG. 31 taken along line 35-35 of FIG. 32;

FIG. 36 is a perspective view of yet another alternative embodiment of a guard assembly having yet another alternative embodiment of a bracket;

FIG. 37 is a perspective view of a portion of a bicycle assembly including yet another alternative embodiment of a bracket;

FIG. 38 is a side view of the embodiment of FIG. 37;

FIG. 39 is a perspective view of a portion of a bicycle assembly including yet another alternative embodiment of a bracket;

FIG. 40 is a side view of the embodiment of FIG. 39;

FIG. 41 is a side view of a portion of a bicycle assembly including yet another alternative embodiment of a bracket; and

FIG. 42 is a perspective view of a guard including a threaded insert.

In describing the preferred embodiment of the invention, which is illustrated in the drawings, specific terminology will be resorted to for the sake of clarity. However, it is not intended that the invention be limited to the specific term so selected, and it is to be understood that each specific term includes all technical equivalents which operate in an analogous manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In this detailed description, various terms relating to direction may be used. The elements discussed herein relate to a bicycle or bicycle assembly. A bicycle or bicycle assembly may be formed of conventional elements, such as the wheels, suspension elements, and drive elements mentioned in this disclosure. Because, in its operable position, a bicycle is oriented generally vertically, i.e., perpendicular to the ground, the direction terms refer to the position of an element relative to gravity when the bicycle is in its operable position. Accordingly, for example, the term “downwardly” refers to the direction towards the ground when the bicycle is in its operable position, and the term “forwardly” relates to a direction towards a front wheel of the bicycle when it is in its operable position. Further, the terms “inboard” and “outboard” may be used. The term “inboard” describes a position between one item and a vertical plane substantially bisecting the bicycle. The term “outboard” describes a position of an object further from the vertical center plane of the bicycle. In addition, the terms “bicycle” and “bike” are used herein interchangeably. A person having ordinary skill in the art will understand that if something is referred to as one, it can refer to the other.

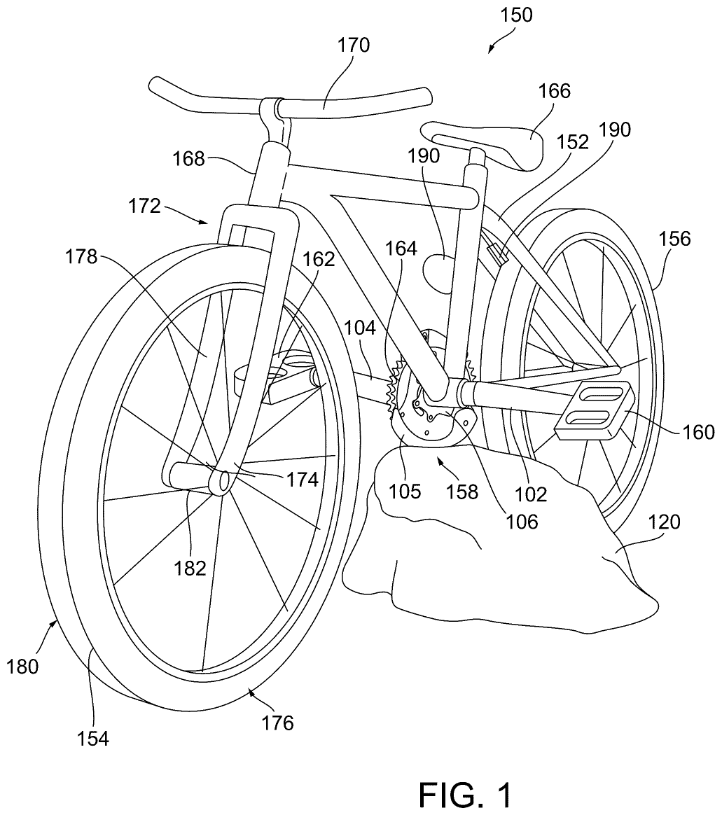

The overall configuration of the present device in the context of a vehicle is shown in FIG. 1. Many of the parts are shown schematically in this FIG., in an overall configuration, rather than illustrating the details of the design. The present guard assembly is configured to be primarily used with a pedaled bicycle, such as the bicycle 150. The device could be used with a powered bicycle, a motorcycle, a moped, or similar vehicle. The bicycle 150 may include a frame 152, a front wheel 154, and a rear wheel 156. The bicycle 150 may further include a drive system 158 that conventionally includes a first pedal 160 and a second pedal 162 positioned generally opposite one another. The first pedal 160 may be attached to a first arm 102 and the second pedal 162 may be attached to a second arm 104. The first arm 102 and the second arm 104 may be attached to a crank axle that is not shown in detail in this FIG, but which passes through the bottom bracket 106 and is also secured to the one or more chain rings 164. When a user desires motive power, the user alternatingly presses the first pedal 160 and the second pedal 162. A conventional chain (not shown) transmits the driving force from the pedals 160, 162, and arms 102, 104, via the crank axle (not shown) and through the front chain ring 164 to a rear chain ring (not shown). The rear chain ring is secured to the rear wheel 156, causing it to rotate about an axle passing therethrough (not shown) and thereby causing the bicycle 150 to move. The bicycle frame 152 conventionally allows for the attachment of a seat 166 that a user sits on when using the pedals 160 and 162. The bicycle frame 152 also conventionally includes a head 168. The head 168 allows for the attachment of handlebars 170 that further attach through the head 168 to a front fork 172. The front fork 172 may include a first leg 174 on a first side 176 of the front wheel 154 and a second leg 178 on a second side 180 of the front wheel 154. The arms 174, 178 may be secured to one another by an axle 182 that passes through the front wheel 154 and allows the front wheel 154 to rotate when the rear wheel 156 is driven. A rear shock absorber 190 may also be included on the bicycle 150. In some embodiments, the bicycle 150 may include a motor 190, which is shown schematically. The motor 190 may be attached to the drive system to impart motive power to the bicycle even when the user does not use the pedals 160, 162. The motor 190 may desirably be an electric motor and may be selected from among a variety of conventional motors used with bicycle assemblies or may be a different motor selected by a designer for a particular implementation.

The present disclosure relates to a guard assembly 105 that may be used to protect a bicycle chain, a chain ring, a motor, a motor mount, the bicycle frame or other sensitive items on the bicycle assembly from damage due to impact with other objects, such as the illustrated rock 120. While the disclosure describes the use of this guard assembly 105 in connection with a bicycle having two wheels, propelled by human action, and being used near a bicycle crank axle, the guard assembly 105 could be used in connection with other types of vehicles and in other places. For example, the guard assembly 105 could be used on a vehicle that uses a belt-drive system instead of a chain-drive system. The guard assembly 105 could be placed adjacent an axle of a bicycle or another rotating part. In many of the disclosed embodiments, the guard assembly 105 is configured to be separate from the bicycle assembly 150 and the frame 152. In other embodiments, one or more elements of the guard assembly 105 could be formed integrally with the bicycle assembly 150 or the bicycle frame 152. The guard assembly 105 could be used in connection with a tricycle or vehicle having a different number of wheels. All of these vehicles are considered to be “bicycles” or “bicycle assemblies” for purposes of the present disclosure.

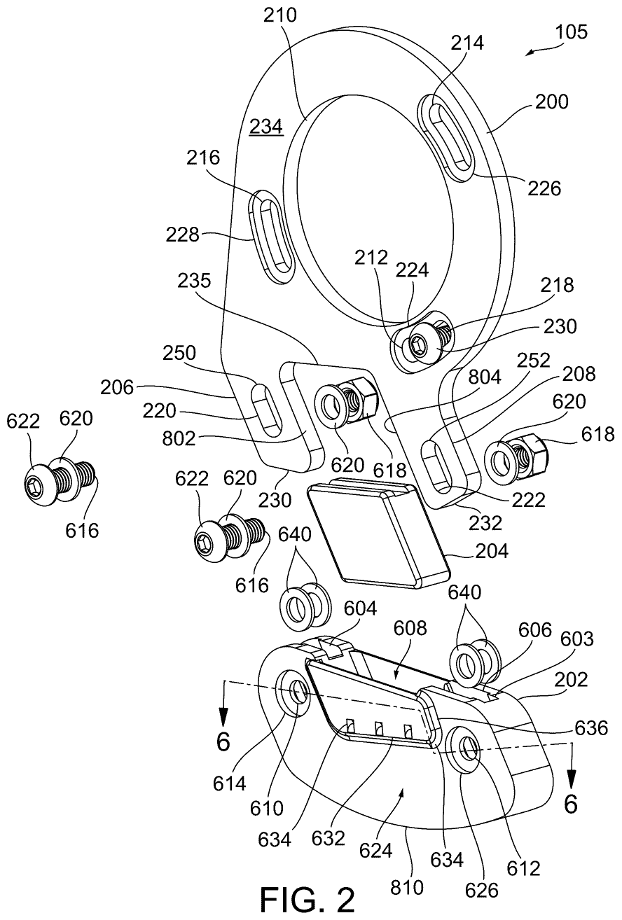

An exploded view of the guard assembly 105 is shown in FIG. 2. The guard assembly 105 includes a bracket 200, a guard 202, and a spring 204. The bracket 200 may include a first arm 206 and a second arm 208. The bracket 200 may define a plurality of apertures or cavities. The bracket 200 may define a crank aperture 210. The crank aperture 210 may be sized and shaped to allow a conventional crank axle and related structure (not shown) to pass therethrough.

The bracket 200 may also define one or more frame attachment apertures. These may be first frame attachment aperture 212, second frame attachment aperture 214, and third frame attachment aperture 216. Each of the frame attachment apertures 212, 214, 216 may be configured with a position, size and shape to allow a frame attachment fastener, such as the exemplary frame attachment fastener 218 to pass therethrough. In a conventional bicycle, there are a plurality of threaded mounting points on the frame 152 (see FIG. 1) that allow the bracket 200 to be attached to the frame 152. In the illustrated embodiments, the bracket is shown as incorporating apertures 212, 214, 216 and fasteners 218 to attach using the International Standard Chain Guide (ISCG) mounting system.

As another exemplary embodiment, the bracket 1500 of FIG. 15 includes apertures 1512, 1514, and 1516 to allow the bracket 1500 to be attached to a bicycle frame, motor or motor mount. However, the central aperture 1510 is a recess-style aperture that may not fully enclose a crankshaft. Other conventional mounting systems apertures may be formed in the bracket 1500 to accommodate different types of mounting strategies and structures.

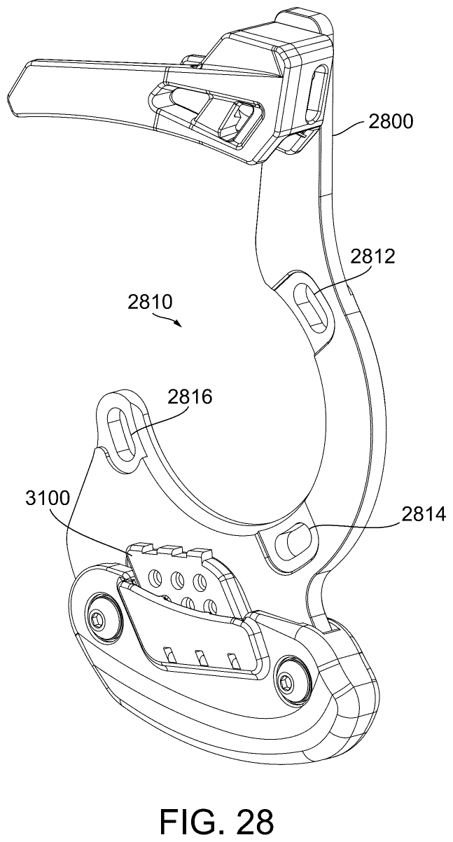

As another exemplary embodiment, the bracket 2800 of FIG. 28 includes apertures 2812, 2814, and 2816 to allow the bracket 2800 to be attached to a bicycle frame, motor or motor mount. However, the central aperture 2810 is a recess-style aperture that may not fully enclose a crankshaft. Other conventional mounting systems apertures may be formed in the bracket 2800 to accommodate different types of mounting strategies and structures.

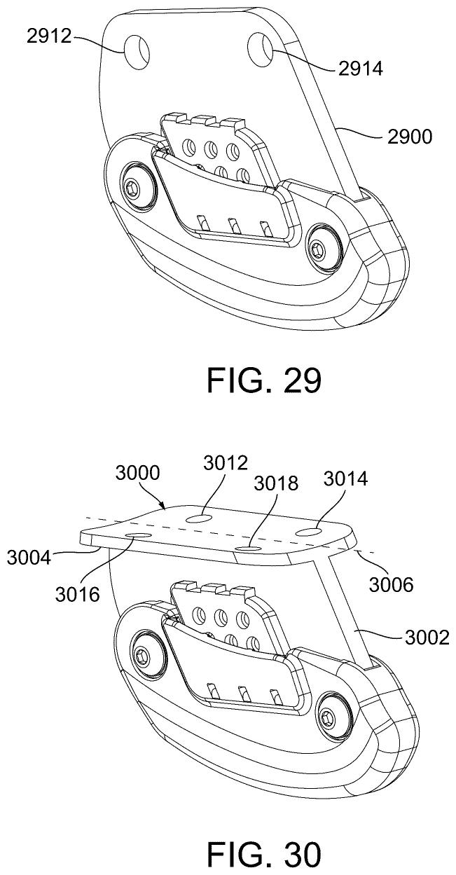

As another exemplary embodiment, the bracket 2900 of FIG. 29 includes apertures 2912 and 2914 to allow the bracket 2900 to be attached to a bicycle frame, motor or motor mount. In the embodiment of FIG. 29, the bracket 2900 need not be attached to the frame in a particular relationship to a crankshaft, because the bracket 2900 lacks any central aperture to accommodate a crankshaft. However, the bracket 2900 may be attached to a lateral side of the frame adjacent the crankshaft, as is conventional. Other conventional mounting systems apertures may be formed in the bracket 2900 to accommodate different types of mounting strategies and structures.

As another exemplary embodiment, the bracket 3000 of FIG. 30 includes apertures 3012, 3014, 3016, and 3018 to allow the bracket 3000 to be attached to a bicycle frame, motor or motor mount. In the embodiment of FIG. 30, the bracket 3000 need not be attached to the frame in a particular relationship to a crankshaft, because the bracket 3000 lacks any central aperture to accommodate a crankshaft. Instead, the bracket 3000 is configured to be attached to a bottom surface of a frame, as is conventional. The bracket 3000 may include a first leg 3002 and a second leg 3004. The first leg 3002 and the second leg 3004 may be substantially perpendicular to one another. The first leg 3002 may be located generally along a center line 3006 of the second leg 3004. Other conventional mounting systems apertures may be formed in the bracket 3000 to accommodate different types of mounting strategies and structures and other configurations of the bracket 3000 may be used to allow it to be secured appropriately to a bicycle frame.

As another exemplary embodiment, the bracket 3600 of FIG. 36 includes apertures 3612 and 3614, along with two other apertures (not shown) allow the bracket 3600 to be attached to a bicycle frame, motor or motor mount. In the embodiment of FIG. 36, the bracket 3600 need not be attached to the frame in a particular relationship to a crankshaft, because the bracket 3600 lacks any central aperture to accommodate a crankshaft. Instead, the bracket 3600 is configured to be attached to a bottom surface of a frame, as is conventional. The bracket 3600 may include a first leg 3602 and a second leg 3604. The first leg 3602 and the second leg 3604 may be substantially perpendicular to one another. The first leg 3602 may be located generally along a center line of the second leg 3604. In the embodiment shown in FIG. 36, the frame portion to which the bracket 3600 is to be attached includes discontinuities. In particular, the frame includes a discontinuity 3608. In order to accommodate this discontinuity and allow the bracket 3600 to be securely attached to the frame, the second leg 3604 of the bracket 3600 may also be formed to incorporate a mating discontinuity 3610. In this embodiment, the first leg 3602 may be configured to accommodate this sort of discontinuity. Other conventional mounting systems apertures may be formed in the bracket 3600 to accommodate diverse types of mounting strategies and structures and other configurations of the bracket 3600 may be used to allow it to be secured appropriately to a bicycle frame.

A variety of brackets are disclosed herein. Each embodiment disclosed may show the use of a particular bracket. A person of ordinary skill in the art will be able to select an appropriate configuration of a bracket for the particular desired use of the guard assembly without undue experimentation.

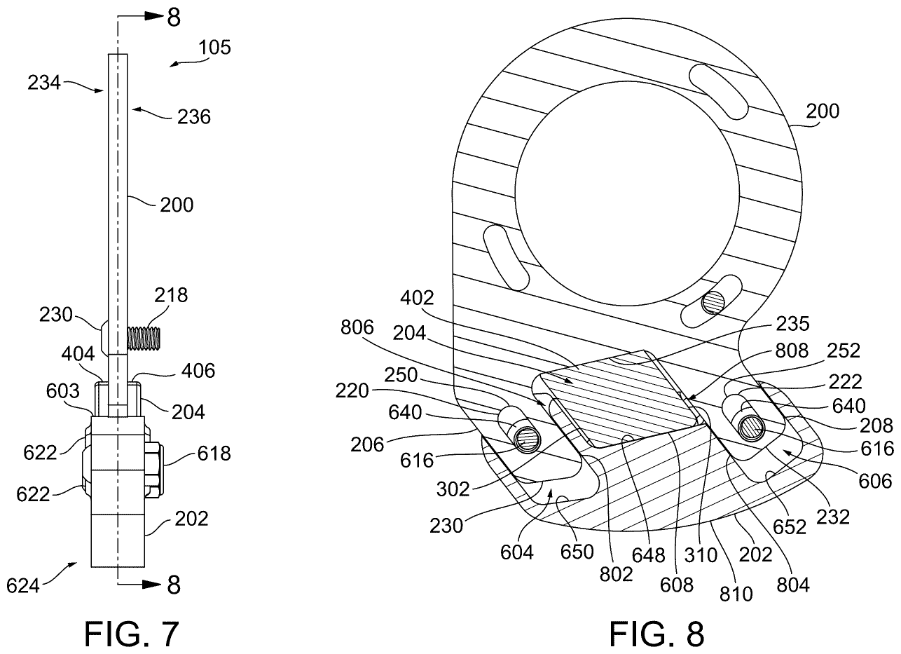

Some of the apertures referred to herein may be surrounded by a recessed area. Returning to FIG. 2, the first fastener aperture 212 in the bracket 200 may be at least partially surrounded by a first fastener aperture recess 224. The second fastener aperture 214 in the bracket 200 may be at least partially surrounded by a second fastener aperture recess 226. The third fastener aperture 216 in the bracket 200 may be at least partially surrounded by a third fastener aperture recess 228. The inclusion of a particular fastener aperture recess 224, 226, 228 adjacent a corresponding fastener aperture 212, 214, 216 may allow for at least a portion of the head 230 of the fastener 218 to pass into the corresponding recess, thereby reducing the sideways projection of the fastener head 230. This reduction in the sideways projection of the head 230 may be best seen in the front view of the assembly 105 shown in FIG. 7. In many embodiments, the fastener head 230 may be rounded to minimize the risk of any obstacles snagging on the fastener.

The bracket 200 may include a first arm 206 and a second arm 208. A first slot 220 may be defined in the first arm 206 and a second slot 222 may be defined in the second arm 208. As shown in FIG. 2, it is not necessary for the first arm 206 to have the same shape and size as the second arm 208. However, in many embodiments, it may be desirable for the first slot 220 to have substantially the same shape and size as the second slot 222. In addition, in many embodiments, it may be desirable for the first slot 220 to be substantially parallel to the second slot 222.

The bracket 200 may further include an engagement surface 235. In many embodiments, the engagement surface 235 may be between the first arm 206 and the second arm 208. The engagement surface 235 may be adjacent the first arm 206, the second arm 208, or both.

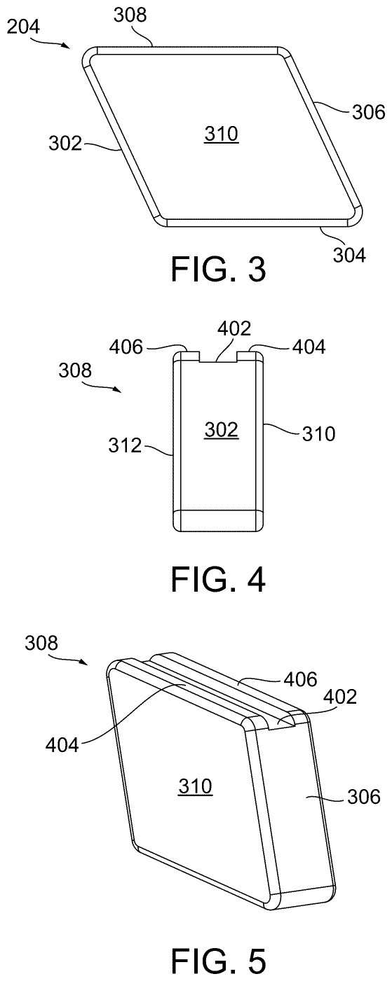

The bracket assembly 105 may further include a spring 204. One embodiment of the spring 204 is seen in greater detail in FIGS. 3-5. The spring 204 may have a first side 302, a second side 304, a third side 306, a fourth side 308, a first face 310, and a second face 312. The first side 302 may be opposite the third side 306, the second side 304 may be opposite the fourth side 308, and the first face 310 may be opposite the second face 312. In some embodiments, the spring 204 may generally be a trapezoidal prism or a parallelepiped. However, in many embodiments, one or more of the sides or faces may be configured more irregularly or to have a different shape. The illustrated spring 204 is shown as being formed from a single material. The shape, size, density and configuration of the spring 204 may affect the compression and expansion properties of the spring 204. The spring 204 may also be configured to incorporate different materials in different positions within the spring 204. A person having ordinary skill in the art will be able to choose a size, shape, material, and configuration of the spring 204 to create a desired spring response to applied loads.

In many embodiments, the spring 204 may made by extruding a material in a shape like that shown in FIG. 4. If the material is extruded, the slot 402 defined in the fourth surface 308 can be made at the time of extrusion. If the material is extruded, it can then be cut and shaped to an appropriate size and shape as desired. Alternatively, the material may be molded to be a particular shape. The top surface 308 of the spring 204 may define a slot 402 having a first shoulder 404 on one side and an opposite second shoulder 406 on an opposite side.

A person of ordinary skill in the art can select any appropriate resilient material that can be appropriately formed into a desired shape for the spring 204. Suitable materials may include elastomeric polymers such as Urethane or TPU which can be molded to have selected material stiffness factors. These materials may provide long term durability and predictable characteristics when exposed to typical outdoor environmental conditions including UV exposure and variations in operating temperature and moisture content. Materials that cycle with varying magnitudes of hysteresis may be beneficial in achieving desired energy absorption and release characteristics for optimal system function. Formed metallic springs may also be utilized.

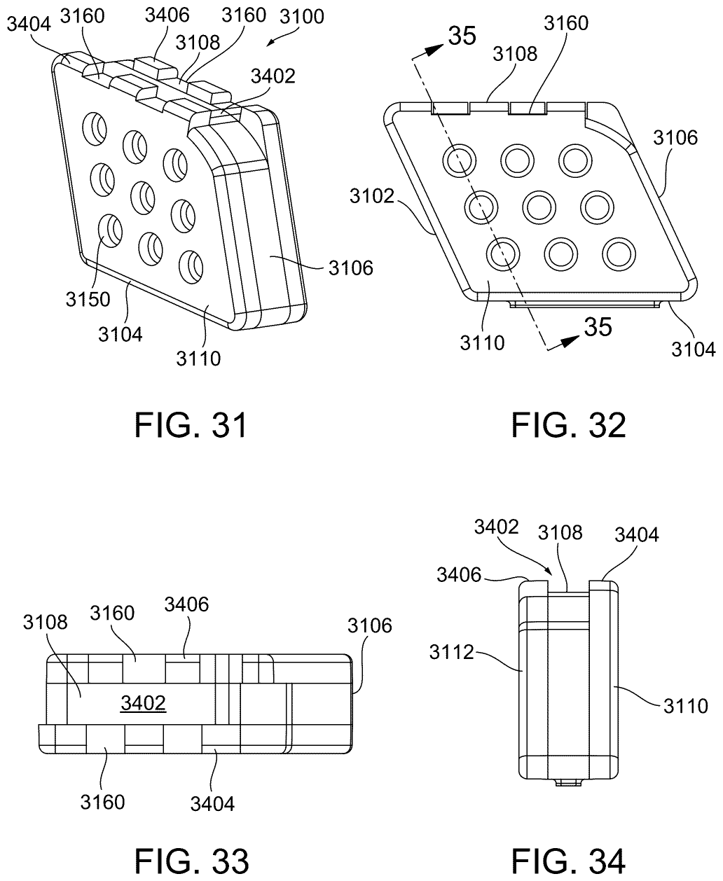

In some embodiments, it may be desirable for the elasticity of the spring to be variable. One alternative embodiment of a spring 3100 is shown in FIGS. 31-35. The spring 3100 may have a first side 3102, a second side 3104, a third side 3106, a fourth side 3108, a first face 3110, and a second face 3112. The first side 3102 may be opposite the third side 3106, the second side 3104 may be opposite the fourth side 3108, and the first face 3110 may be opposite the second face 3112. In some embodiments, the spring 3100 may generally be a trapezoidal prism or a parallelepiped. However, in many embodiments, one or more of the sides or faces may be configured more irregularly or to have a different shape. The illustrated spring 3100 is shown as being formed from a single material. The shape, size, density and configuration of the spring 3100 may affect the compression and expansion properties of the spring 3100. The spring 3100 may also be configured to incorporate different materials in different positions within the spring 3100. A person having ordinary skill in the art will be able to choose a size, shape, material, and configuration of the spring 3100 to create a desired spring response to applied loads.

In many embodiments, a slot 3402 may be defined in the fourth surface 3108 and can be made at the time of molding. The top surface 3108 of the spring 3100 may define a slot 3402 having a first shoulder 3404 on one side and an opposite second shoulder 3406 on an opposite side.

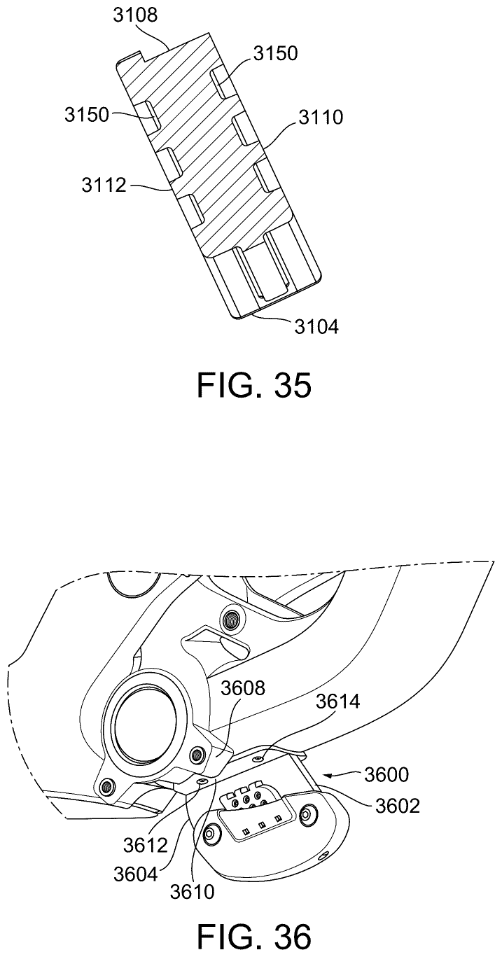

The spring 3100 as illustrated may desirably be formed by molding. A mold configured to form a spring 204 like that shown in FIGS. 3-5 may be used. One or more inserts may be positioned within the mold, as is well-known in the art. The inserts may be configured with one or more projections thereon. When the material to be molded enters the mold, the material may flow around the projections. When the mold is opened, cavities like the cavities 3150 may be formed in the sides 3110 and 3112 of the spring 3100. In some embodiments, the insert may also be positioned to create discontinuities, such as discontinuities 3160 in the shoulders 3404, 3406 of the upper surface 3108 of the spring 3100. In some embodiments, it may be desirable for the cavities 3150 to be aligned in the spring 3100, as may be best seen in FIG. 35. In some embodiments, it may be desirable for the discontinuities 3160 to be offset from one another, as may be best seen in FIG. 33. A person of ordinary skill in the art will be able to design a mold that will create cavities 3150 and discontinuities 3160 as may be desired to create an appropriate spring profile for the spring 3100 without undue experimentation. While the embodiment shown in FIGS. 31-35 shows discontinuities only on one surface, discontinuities can be created on other surfaces as well. Changes in the amount of material in the spring 3100 and changes to the position of that material may affect the spring constant and how the spring 3100 resists compression and rebounds to its initial position. A spring having features like those shown in the spring 3100 may be used in any of the other embodiments shown. Similarly, for embodiments where a spring like the spring 3100 is shown, a spring like spring 204 may be used instead. Other changes to the spring may be made, such as a change in thickness, material, and the like, which will create other changes known to persons of skill in the art and all of which fall within the scope of the term “spring” as used in this document.

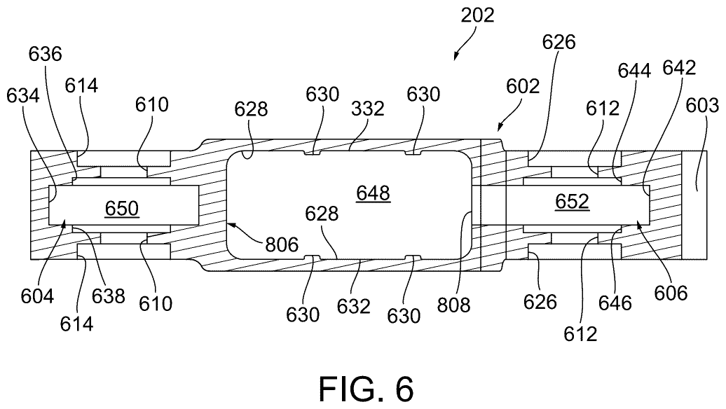

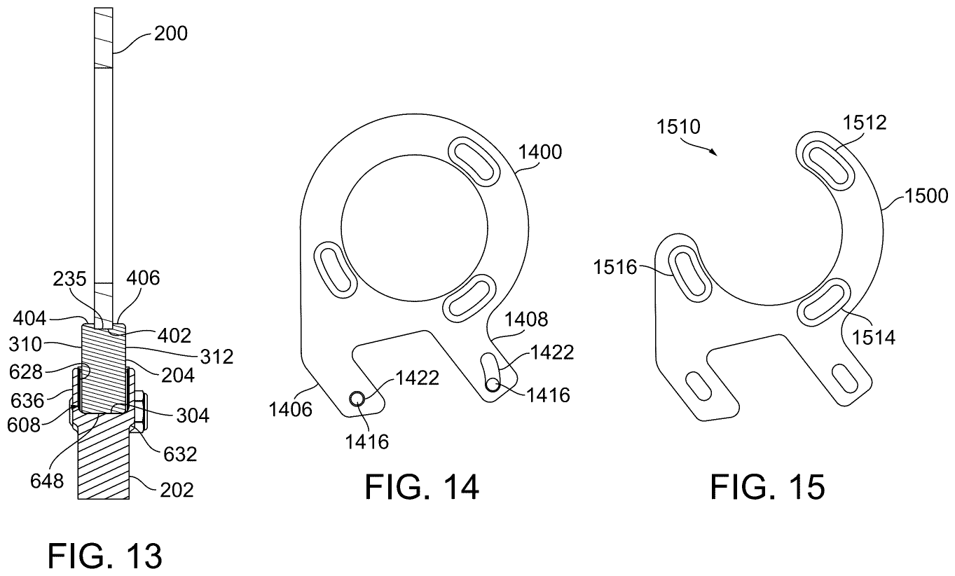

In many embodiments, the spring 204 and the bracket 200 may be configured to interfit with one another. This interfitting may be best seen in FIGS. 7, 8 and 13. As may be seen, the notch or slot 402 in the spring 204 may be placed adjacent the engagement surface 235 of the bracket 200. As may best seen in FIGS. 7 and 13, when the slot 402 is placed against the engagement surface 235 of the bracket 200, the first shoulder 404 may project upwardly and engage a first side 234 of the bracket 200. The second shoulder 406 may project upwardly and engage a second side 236 of the bracket 200. In some embodiments, the first shoulder 404 may be spaced from, but adjacent to the first side 234 of the bracket 200, the second shoulder 406 may be spaced from, but adjacent to the second side 236 of the bracket 200, or both. The use of a slot 402 and shoulders 404, 406 may serve to position the spring 204 against the bracket 200 without risking a great deal of relative movement between the bracket 200 and the spring 204 or the dislodging of the spring 204 from the bracket 200 during operation. This relative positioning may be best seen in FIG. 13. While a slot 402 is shown, the use of the slot 402 may be optional. If no slot 402 is used, it may be desirable to incorporate a different retention structure into the engagement surface 235. The retention structure or engagement surface may take the form of a pocket like the cavity 602 in the guard 202 (also see FIG. 6), a finger that punctures the spring 204 to retain it in place, or another mechanical or chemical mounting or retention structure that is appropriate for the materials selected for the bracket 200 and the spring 204.

As may be best seen in FIG. 8, the first face 302 of the spring 204 may be adjacent to, but spaced from, the rear face 802 of the first leg 206. In some embodiments, it may be desirable for the rear face 802 of the first leg 206 to be immediately proximate the first face 302 of the spring 204. The third face 310 of the spring 204 may be adjacent to, but spaced from, the front face 804 of the second leg 208. In some embodiments, it may be desirable for the third face 310 of the spring 204 to be immediately proximate the front face 804 of the second leg 208. A first dividing portion 806 of the guard 202 may be interposed between the spring 204 and the first leg 206. A second dividing portion 808 of the guard 202 may be interposed between the spring 204 and the second leg 208. The spring 204 may be laterally spaced from either or both dividing portions 806, 808. This spacing may be desirable to allow the spring to deform when it is compressed. When the spring and dividing portions are spaced in such a way, they may be able to compress and absorb impact energy in a more predictable and robust manner.

The structure of the guard 202 may be best understood by an examination of FIGS. 2, 6, 8, and 16. The guard 202 may be configured to define a cavity 602 in its top surface 603. The cavity 602 may have three portions or lobes separated from one another by dividing portions. The cavity 602 may have a first lobe 604 that is shaped and sized for allowing the first leg 206 to reciprocate therein. The cavity 602 may have a second lobe 606 that is shaped and sized for allowing the second leg 208 to reciprocate therein. In some embodiments, the first lobe 604 may be substantially the same shape and size as the second lobe 606. The guard 202 may further have a first fastener aperture 610 that extends through the guard 202 transverse to the first lobe 604. The guard 202 may further have a second fastener aperture 612 that extends through the guard 202 transverse to the second lobe 606. Each fastener aperture 610, 612 may be configured to allow a fastener to pass therethrough. In many embodiments, a threaded fastener 616 may be configured to pass through the first fastener aperture 610 in the guard 202. A corresponding threaded nut 618 may be configured to rotatably join the threaded fastener 616 to secure the threaded fastener 616 in place. Another substantially identical threaded fastener 616 may pass through the second fastener aperture 612 in the guard 202 and engage a substantially identical threaded nut 618. In many embodiments, a washer 620 may be positioned between the head 622 of the fastener 616 and the outer surface 624 of the guard 202. In many embodiments, another washer 620 may be positioned between the nut 618 and the outer surface 624 of the guard 202. In many embodiments, all the washers numbered 620 may be substantially identical. In other embodiments, a person of ordinary skill in the art may select different washers 620 based on the materials from which the fasteners 616 and nuts 618 are made of or for any other desirable reason. In some embodiments, it may be desirable to form the washers 620 out of an elastomer. The use of an elastomer may allow the washers 620 to resiliently absorb impact that has a lateral component that may not be fully absorbed by other structures described herein.

Some of the apertures referred to herein may be surrounded by a recessed area. The first fastener aperture 610 in the guard 202 may be surrounded by a first fastener aperture recess 614. The second fastener aperture 612 in the guard 202 may be surrounded by a second fastener aperture recess 626. As may be seen most clearly in FIG. 6, each of the fastener apertures 610, 612 may extend through guard 202 and may pass through a corresponding recess lobe 604, 606. Each side of the fastener aperture 610, 612 may have a corresponding fastener aperture recess 614, 626 surrounding the corresponding fastener aperture 610, 612 on each side of the guard 202. The inclusion of a particular fastener aperture recess 614, 626 adjacent a corresponding fastener aperture 610, 612 may, on one side, allow for at least a portion of the washer 620 and, in some embodiments, a portion of the head 622 of the fastener 616 to pass into the recess, thereby reducing the sideways projection of the fastener head 622. The inclusion of a particular fastener aperture recess 614, 626 adjacent a corresponding fastener aperture 610, 612 may, on an opposite side, allow for at least a portion of the washer 620 and, in some embodiments, a portion of the threaded nut 618 to pass into the recess, thereby reducing the sideways projection of the threaded nut 618. This reduction in the sideways projection of the head 622 and the nut 618 from each recess 614, 626 may be best seen in the back view shown in FIG. 7. In many embodiments, the fastener head 622 and/or the nut 618 may be rounded to minimize the risk of any obstacles snagging on the fastener 616 or nut 618.

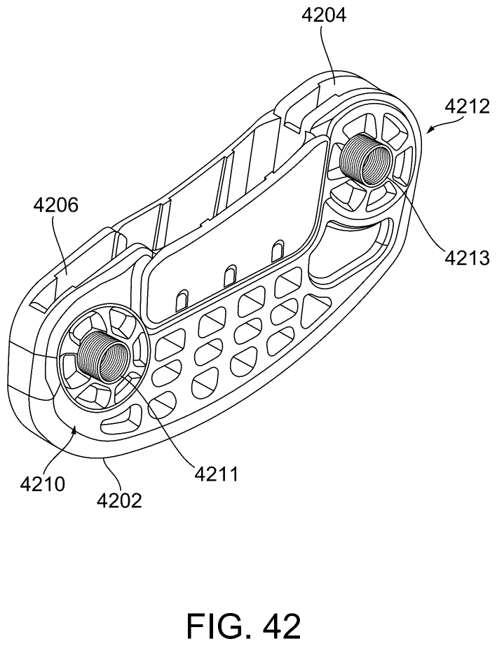

An alternative embodiment is shown in FIG. 42. In the embodiment of FIG. 42, the guard 4202 may include a first fastener aperture 4210 and a second fastener aperture 4212. In some embodiments, it may be desirable to reinforce the fastener apertures 4210, 4212. In the illustrated alternative embodiment, a first insert 4211 may be inserted into the first fastener aperture 4210. A second insert 4213 may be inserted into the second fastener aperture 4212. Corresponding inserts may be inserted into the opposite side of the guard 4202 (not shown). The inserts may be smooth or threaded, as desired by the designer. In some embodiments, the respective arms of the bracket (not shown) may be inserted into the first lobe 4204 and the second lobe 4206. Then an insert may be inserted into each of the apertures 4210, 4212 and extend across the guard 4202 and through the slot (not shown) in the respective bracket arm. The use of such an insert may allow for greater durability of the assembly in use. In some embodiments, when the insert is threaded, the insert may be used instead of, or in addition to, a separate fastener.

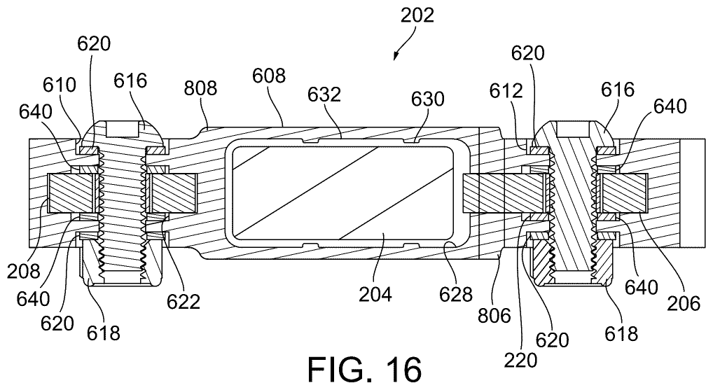

As was described above and will be described further below, the spring 204 may be placed in the third lobe 608 and the third lobe 608 may therefore be considered to be a spring lobe or a spring cavity. The third lobe 608 and the spring 204 may be shaped and sized such that the entire volume of the spring 204 does not fill the third lobe 608. This spacing may be best seen in FIG. 16. The spring 204 may be shaped and sized in a manner to allow the spring 204 to expand when it is compressed by the operation of the guard assembly 105 as will be described in greater detail elsewhere in this disclosure. Because the spring 204 is spaced from at least one interior surface 628 of the third lobe 608, dirt and debris may enter the third lobe 608 between the spring 204 and the interior surface 628 of the third lobe 608. In order for the guard assembly 105 to function optimally, it may be desirable to remove the dirt and debris within the third lobe 608, as may be best seen in FIG. 6. Accordingly, one or more reliefs 630 may be included in a lower edge 632 of the third lobe 608. In another embodiment, the reliefs could be positioned elsewhere in the third lobe 608, such as in a corner 634 or along a side 636. The precise size, shape, and location of the reliefs, along with whether they are included at all may be appropriately determined by a person of ordinary skill in the art and will depend on the predicted material to be removed from the third lobe 608, along with such considerations as the shape, size and material of the spring 204 and the guard 202.

Returning to FIG. 6, the guard 202 may also be configured to receive and optionally to retain one or more washers within the first lobe 604 and the second lobe 606. In many embodiments, the interior surface 634 of the first lobe 604 may be configured to include a first projection 636 and a second projection 638. These projections may be configured to allow for the appropriate positioning of one or more washers 640 (see FIG. 2) that may fit against the interior surface 634 of the first lobe 604 and allow the fastener 616 to pass therethrough. Similarly, the interior surface 642 of the second lobe 606 may be configured to include a first projection 644 and a second projection 646. These projections may be configured to allow for the appropriate positioning of one or more washers 640 (see FIG. 2) that may fit against the interior surface 642 of the second lobe 606 and allow the fastener 616 to pass therethrough.

In many embodiments, the lobes 604, 606, and 608 may form a single cavity. In other embodiments, the lobes 604, 606, and 608 may at least partially be mechanically separated from one another. In some embodiments, the first lobe 604 may be separated from the third lobe 608 by a spacer or wall 806. In some embodiments, the second lobe 606 may be separated from the third lobe 608 by a spacer or wall 808. In many embodiments, the walls 806, 808 are desirably used to minimize the risk of the spring 204 contacting either the first arm 206 or the second arm 208, whether in rest configuration or in operation. The walls 806, 808 may also serve to minimize the intrusion of dirt and debris from the third lobe 608 into the first lobe 604 and/or the second lobe 606. Further, the inclusion of the walls 806, 808 may increase the lateral stability of the guard 202 and reduce the likelihood that the guard 202 will be deformed upon impact with an obstacle. In some embodiments, the walls 806, 808 may incorporate fingers (not shown) at a desired vertical position to position and hold the interior washers 640 (see FIG. 2) in place within the guard 202 during assembly.

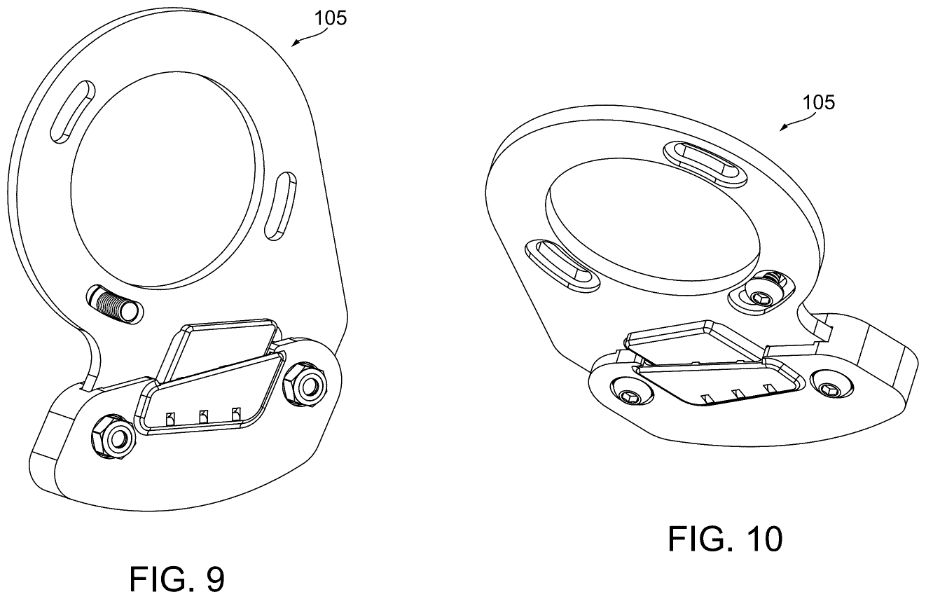

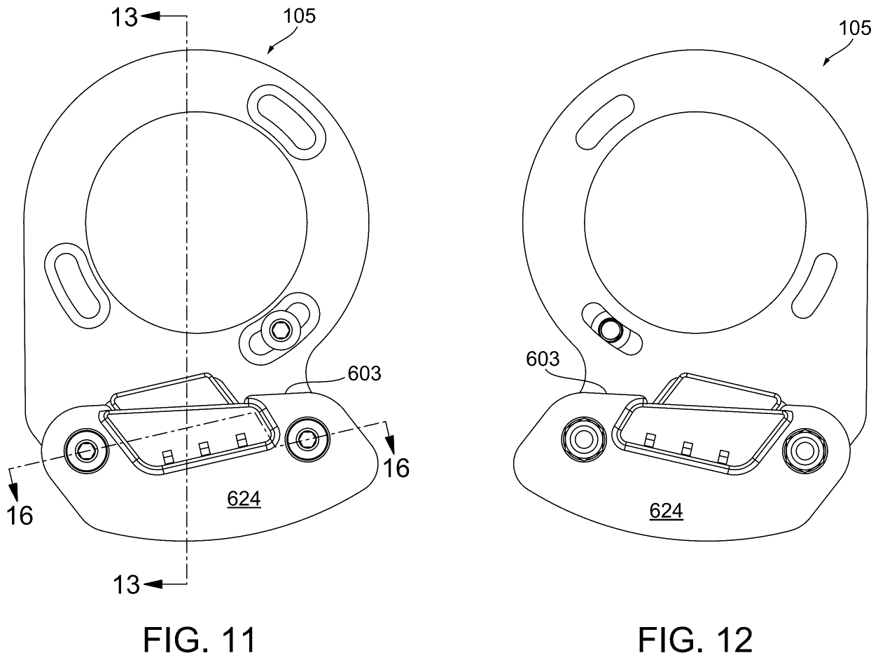

Having examined the structure of many of the main elements of the guard assembly 105, this disclosure now turns to the process of assembling the elements to form the guard assembly 105. Various aspects of the assembly 105 may be visible in different images. Various views of the entire assembly may be seen in FIGS. 7, 9, 10, 11, and 12.

To form the guard assembly 105, the spring 204 may be inserted into the third lobe 608. In most embodiments, the spring 204 may be sized and shaped so that the bottom surface 304 of the spring 204 may rest against the bottom surface 648 of the third lobe 608. The spring 204 may be sized and shaped so that the first face 310 and the second face 312 of the spring 204 may each be spaced from the interior surface 628 of the third lobe 608, as is best seen in FIG. 16. The spring 204 may be sized and shaped so that at least one of the lateral sides 302, 306 may be spaced from at least one of the walls 806, 808.

The first arm 206 may be inserted into the first lobe 604 between the two washers 640. The second arm 208 may be inserted into the second lobe 606 between the two washers 640. In most embodiments, the steps of inserting the first arm 206 into the first lobe 604 and inserting the second arm 208 into the second lobe 606 may be done substantially simultaneously. The washers 640 may be inserted into the first lobe 604 and the second lobe 606 onto the respective projections 636, 638, 644, 646 after the first arm 206 and the second arm 208 are inserted onto the respective lobes 604, 606. In some embodiments, the free end 230 of the first arm 206 may be sized and shaped to be capable of resting against the bottom surface 650 of the first lobe 604. The free end 232 of the second arm 208 may be sized and shaped to be capable of resting against the bottom surface 652 of the second lobe 606. The engagement surface 235 may also become inserted into the slot 402 in the spring 204 when the arms 206, 208 are inserted into the respective lobes 604, 606. After the insertion step, the slot 220 in the first arm 206 may be positioned adjacent the first fastener aperture 610 in the first lobe 604 of the guard 202. A washer 620 may be placed on the fastener 616 and the fastener 616 may then be inserted through the first fastener aperture 610, through the first slot 220, and through the two washers 640 within the first lobe 604. A second washer 620 may then be placed on the fastener 616 and the nut 618 attached to the fastener 616. Also after the insertion step, the slot 222 in the second arm 208 may be positioned adjacent the second fastener aperture 612 in the second lobe 606 of the guard 202. A washer 620 may be placed on the fastener 616 and the fastener 616 may then be inserted through the second fastener aperture 612, through the second slot 222, and through the two washers 640 within the second lobe 606. A second washer 620 may then be placed on the fastener 616 and the nut 618 attached to the fastener 616.

In the described and illustrated embodiments, the fastening structures have been described as being separate from the bracket 200 and the guard 202. However, a person of ordinary skill in the art can modify the design to make some or all of the fastening structures integrally with the remainder of the design. In some embodiments, the nut 618 may be formed integral with the guard 202. In some embodiments of this sort, the guard may be molded to embed the nut 618 within it. In other embodiments, where the material of the guard has the capacity to perform this function, threads may be molded into the guard and the nut may therefore be integral with the guard. A person of ordinary skill in the art may also be able to incorporate one or more of the washers into the guard in an analogous manner if desired by the designer without negatively affecting the function of the overall structure. These structures and methods are well known in the art and can be added without undue experimentation.

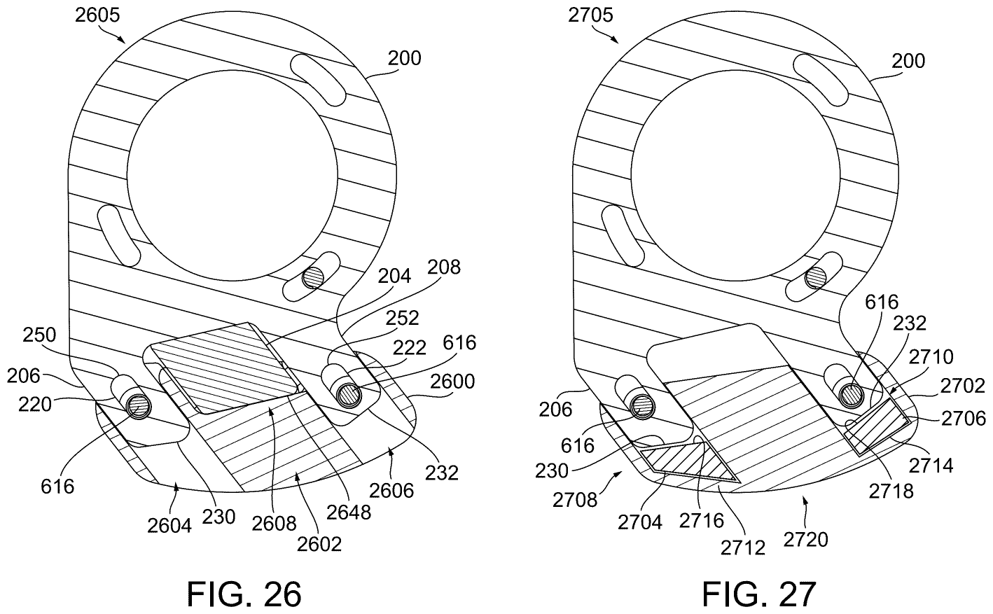

An alternative embodiment of the guard 202 may be seen in FIG. 26. The alternative guard is numbered 2600. The assembly 2605 of FIG. 26 may include a bracket 200 and a spring 204 and related, unnumbered parts that are substantially identical to those disclosed in connection with other embodiments. Where features of these aspects are not discussed in connection with this FIG. a person of ordinary skill in the art will be able to make the appropriate modifications without undue experimentation. As discussed in connection with the earlier embodiments, it may be desirable to create passageways through the cavity 2602 of the guard 2600. In the embodiment shown in FIG. 26, the first lobe 2604 of the cavity 2602 may pass entirely through the guard 2600 and have no bottom. Similarly, the second lobe 2606 of the cavity 2602 may pass entirely through the guard 2600 and have no bottom. In a more complicated arrangement, some or all of the bottom 2648 of the third lobe 2608 may be removed, instead of or in addition to the inclusion of the reliefs around the periphery of the third lobe 2608. The use of this style of cavity 2602 with a reduced or absent lower surface may allow for dirt and debris to more easily be removed from the cavity 2602, may reduce the size and weight of the guard 2600, and may allow a user greater access to the legs 206, 208, and particularly their respective bottom surfaces 230, 232. It will be apparent to one of ordinary skill in the art that in a configuration shown in FIG. 26, the extreme compressed position of the spring 204 may be governed by the impact of the fasteners 616 on the respective top ends 250, 252 of the respective slots 220, 222 in the respective arms 206, 208. The absence of a lower surface on the first lobe 2604 and the second lobe 2606 may allow for a deeper compression of the spring 204 in some embodiments, because the designer need not be as concerned about material fatigue due to impact between a respective free end 230, 232 of a respective arm 206, 208 on an absent floor or bottom of the cavity. A person of ordinary skill in the art may make these modifications without undue experimentation.

In some embodiments, no other steps need to be performed after the arms 206, 208 are positioned within the lobes 604, 606 and secured therein. A fastener 218 may then be inserted into one or more of the fastener apertures 212, 214, 216 and further attached to a bicycle. In other embodiments, however, it may be desirable to further control the threshold at which the guard 202 moves and the spring 204 compresses. This can be controlled by pre-loading the spring 204.

In an embodiment where the spring 204 is to be pre-loaded, after the arms 206, 208 are inserted into the respective lobes 604, 606, the free ends 230, 232 of the arms 206, 208 may remain spaced from the respective bottom surfaces 650, 652 of the respective lobes 604, 606. The cross-section shown in FIG. 8 shows one example of a spacing between the free ends 230, 232 and the bottom surfaces 650, 652. If a user desires it, an upward force can then be applied to the bottom surface 810 of the guard 202 to change or adjust the position of the guard 202 relative to the bracket 200. Application of this force may cause the arms 206, 208 to move or slide within the respective lobes 604, 606 to a position where the respective free ends 230, 232 are closer to or touch the respective bottom surfaces 650, 652. The nuts 618 may then be tightened to clamp the arms 206, 208 within the respective lobes 604, 606. In some embodiments, the clamping force applied by the fasteners 616 and nuts 618 may effectively be zero and allow the arms 206, 208 to freely slide into and out of the respective lobes 604, 606. The materials from which the interior washers 640 and the arms 206, 208 are made may be selected to provide desirable sliding characteristics between the arms 206, 208 and the washers 640, and therefore also between the bracket 200 and the guard 202 when they are assembled. It may be desirable for the interior washers 640 to provide less frictional force against the arms 206, 208 than would be provided by the material from which the guard 202 is formed. In practice, the preloading of the spring 204 may cause a deformation of the spring 204, thereby changing the size and shape of the spring 204 from a rest configuration where the spring 204 is not preloaded. In some embodiments, a visual indicia (not shown) may be included on one or both of the arms 206, 208 to assist a user in appropriately positioning the guard 202 in particular preloaded positions to achieve different levels of absorption of force and/or different thresholds of impact before the spring 204 absorbs force.

In use, the guard 202, and in particular the bottom surface 810 of the guard 202 may contact an obstacle, such as the rock 120 shown in FIG. 1. When an obstacle is encountered, a force may be applied to the guard 202. In general, the force applied to the guard 202 is likely to be against the lower surface 810 of the guard 202 and in a direction upward and backward from the standard position of the guard 202. When the force applied by the obstacle exceeds the combined opposite spring force applied by the spring 204 against the bottom surface 648 of the third lobe 608 and the clamping force applied by the engagement of the fasteners 616 and nuts 618 against the respective washers 640 and arms 206, 208, then the guard 202 may move from its rest position or rest configuration. The arms 206, 208 may then move more deeply into the respective lobes 604, 606. The slots 220, 222 may slide relative to the fixed fasteners 616. When the slots 220, 222 are substantially linear relative to the bracket 200, as shown in the majority of the FIGS., the movement of the guard 202 may also be substantially linear or lateral relative to the bracket 200. The spring 204 may be compressed between the engagement surface 235 of the bracket 200 and the bottom surface 648 of the third lobe 608. The sliding and compression may continue until one of the top ends 250, 252 of the respective slots 220, 222 contacts the respective fastener 216 or one of the free ends 230, 232 contacts a respective bottom surface 650, 652 of a respective lobe 604, 606. Either contact may substantially mechanically stop relative movement between the guard 202 and the bracket 200. The sliding and compression may alternatively continue until the force applied to the bottom 810 of the guard 202 diminishes and the spring force from the spring 204 exceeds the force applied to the guard 202. The resilience of the spring 204 may then return the guard 202 to its initial position relative to the bracket 200.

The initial rest position or configuration and the extreme compressed position or configuration of the assembly 105 may be selected by a person of ordinary skill in the art. In particular, a person of ordinary skill in the art may adjust the sizes and shapes of one or a variety of components in the guard assembly 105 to optimize the protection of other parts of the bicycle. Bash guard assemblies such as the guard assembly 105 may typically be used to protect more sensitive and/or more expensive portions of the bicycle. In many embodiments, both the initial position and the fully compressed position may be selected to minimize the risk of an obstacle contacting and damaging a chain ring and/or a motor. In particular, in many embodiments, the lower surface 810 of the guard 202 may desirably be positioned lower than any other sensitive bicycle component, whether the guard assembly is in its rest configuration or its fully compressed configuration. This positioning may be no different from other guard assemblies. However, the inclusion of a spring may allow for a user to have a more pleasant ride, allowing impact force to be dissipated by a spring, rather than the impact force being fully transmitted to the rider's body.

An alternative embodiment of a bracket 1400 is shown in FIG. 14. The bracket of FIG. 14 is similar to the bracket 200 in many ways. The structures not specifically discussed in FIG. 14 that are common to both the bracket 200 and the bracket 1400 will be understood to be the same. A person of ordinary skill in the art will understand the modifications without undue experimentation. In the embodiment using the bracket 200, the slots 220, 222 in the arms 206, 208 may be generally linear. The linear configuration of the slots 220, 222 was described as allowing the guard 202 to move substantially linearly or laterally, substantially along the slots 220, 222. In the embodiment of FIG. 14, the first leg 1406 may have an aperture 1422 through which a fastener 1416 may pass. The second leg 1408 may have a curved slot 1422 through which a fastener 1416 may pass. If the bracket 1400 of FIG. 14 were substituted for the previously disclosed bracket 200, the guard 202 would move substantially rotationally relative to the bracket 1400, rather than linearly. In such a configuration, other modifications may be desirable, such as whether the spring 204 would have a similar compressibility throughout or be configured to allow for different compressibility. A person of ordinary skill in the art is able to make these adjustments without undue experimentation.

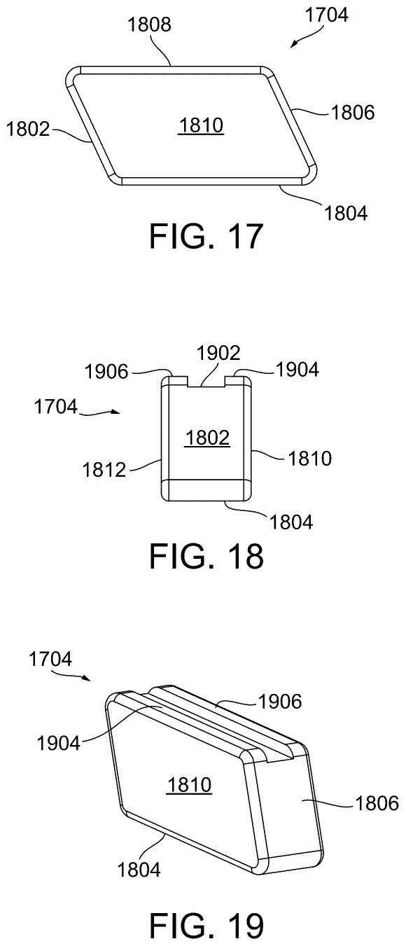

An alternative embodiment of the spring 1704 and how it interacts with the other parts may be seen in FIGS. 17-22. The spring 1704 may have a first side 1802, a second side 1804, a third side 1806, a fourth side 1808, a first face 1810, and a second face 1812. The first side 1802 may be opposite the third side 1806, the second side 1804 may be opposite the fourth side 1808, and the first face 1810 may be opposite the second face 1812. In some embodiments, the spring 1704 may generally be a trapezoidal prism or a parallelepiped. However, in many embodiments, one or more of the sides or faces may be configured more irregularly or to have a different shape. The illustrated spring 1704 is shown as being formed from a single material. The shape, size, density and configuration of the spring 1704 may affect the compression and expansion properties of the spring 1704. The spring 1704 may also be configured to incorporate varied materials in various positions within the spring 1704. A person having ordinary skill in the art will be able to choose a size, shape, material, and configuration of the spring 1704 to create a desired spring curve.

In many embodiments, the spring 1704 may made by extruding a material in a shape like that shown in FIG. 18. If the material is extruded, the slot 1902 defined in the fourth surface 1808 can be made at the time of extrusion. If the material is extruded, it can then be cut and shaped to an appropriate size and shape as desired. Alternatively, the material may be molded to be a particular shape.

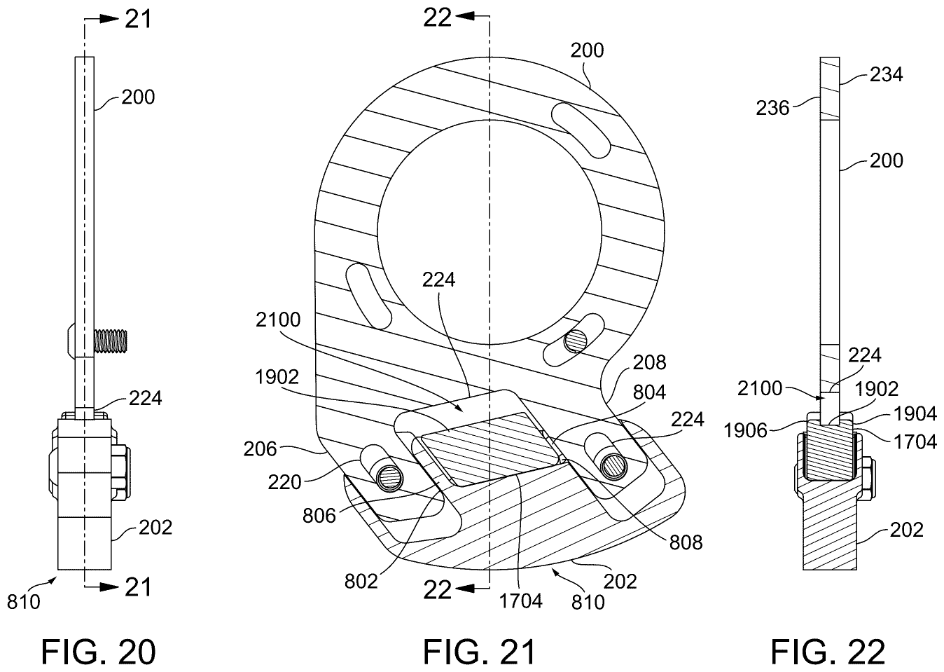

In many embodiments, the spring 1704 and the bracket 200 may be configured to interfit with one another. This interfitting may be best seen in FIGS. 20-22. As may be seen, the notch or slot 1902 in the spring 1704 may be placed adjacent the engagement surface 224 of the bracket 200. However, the spring 1704 may differ from the spring 204 disclosed earlier herein. In the earlier embodiment, the slot 402 was disclosed as being immediately adjacent the engagement surface 224 on the bracket 200. However, in this alternative embodiment of the spring 1704, the slot 1902 may be spaced from the engagement surface 244 by a gap 2100. The top surface 1808 of the spring 1704 may define a slot 1902 having a first shoulder 1904 on one side and an opposite second shoulder 1906 on an opposite side. When the slot 1902 is moved through the gap 2100 to be placed against the engagement surface 224 of the bracket 200, the first shoulder 1904 may project upwardly and engage a first side 234 of the bracket 200. The second shoulder 1906 may project upwardly and engage a second side 236 of the bracket 200. In some embodiments, the first shoulder 1904 may be spaced from, but adjacent to the first side 234 of the bracket 200, the second shoulder 1906 may be spaced from, but adjacent to the second side 236 of the bracket 200, or both. The use of a slot 1902 and the shoulders 1904, 1906 may serve to position the spring 204 against the bracket 200 without risking a great deal of relative movement between the bracket 200 and the spring 1704 or the dislodging of the spring 1704 from the bracket 200 during operation.

The first side 1802 of the spring 1704 may be adjacent to but spaced from the rear face 802 of the first leg 206. In some embodiments, it may be desirable for the rear face 802 of the first leg 206 to be immediately proximate or adjacent the first side 1802 of the spring 1704. The third face 1806 of the spring 1704 may be adjacent to but spaced from the front face 804 of the second leg 208. In some embodiments, it may be desirable for the third face 1806 of the spring 1704 to be immediately proximate the front face 804 of the second leg 208. As shown in FIG. 21, a first dividing portion 806 of the guard 202 may be interposed between the spring 1704 and the first leg 206 and a second dividing portion 808 of the guard 202 may be interposed between the spring 1704 and the second leg 208. As is also shown in FIG. 21, the spring 1704 may be laterally spaced from either or both dividing portions 806, 808. This spacing may be desirable to allow the spring to deform when it is compressed into the space between the spring and one or both of the dividing portions 806, 808. When the spring is spaced in such a way, it may be able to compress and absorb impact energy in a more predictable and robust manner.

In operation, in this embodiment, the guard 202, and in particular the bottom surface 810 of the guard 202 may contact an obstacle, such as the rock 120 shown in FIG. 1. When an obstacle is encountered, a force may be applied to the guard 202. In general, the force applied to the guard 202 is likely to be against the lower surface 810 of the guard 202 and in a direction upward and backward from the standard position of the guard 202. Because the spring 1704 is spaced from the engagement surface 224 of the bracket 200, the guard 202 may slide linearly substantially freely along the slots 220, 224 in the respective first leg 206 and second leg 208 of the bracket 200. When the guard 202 has moved upwardly through the gap 2100, the spring 1704, and particularly the slot 1902 defined in the spring 1704, may contact the engagement surface 224. The spring 1704 may then deform based on the upward force applied to the guard 202 and the characteristics of the spring 1704. When the force applied by the obstacle exceeds the combined opposite spring force applied by the spring 1704 against the bottom surface 648 of the third lobe 606 and the clamping force applied by the engagement of the fasteners 616 and nuts 618 against the respective washers 640 and arms 206, 208, then the guard 202 may continue to move relative to the bracket 200. The arms 206, 208 may then move more deeply into the respective lobes 604, 606. The slots 220, 222 may slide relative to the fixed fasteners 616. When the slots 220, 222 are substantially linear relative to the bracket 200, as shown in the majority of the FIGS., the movement of the guard 202 may also be substantially linear or lateral relative to the bracket 200. The spring 1704 may be compressed between the engagement surface 224 of the bracket 200 and the bottom surface 648 of the third lobe 608. The sliding and compression may continue until one of the top ends 250, 252 of the respective slots 220, 222 contacts the respective fastener 216 or one of the free ends 230, 232 contacts a respective bottom surface 650, 652 of a respective lobe 604, 606 and substantially mechanically stops relative movement between the guard 202 and the bracket 200. The sliding and compression may alternatively continue until the force applied to the bottom 810 of the guard 202 diminishes and the spring force from the spring 1704 equals or exceeds the force applied to the guard 202. The resilience of the spring 1704 may then return the guard 202 to its initial position relative to the bracket 200.

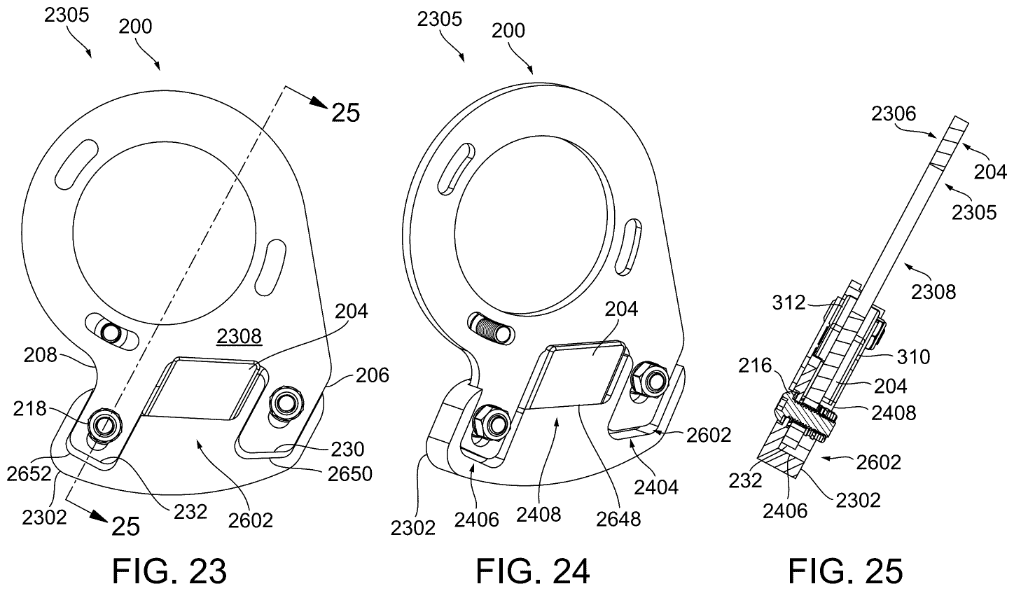

Another alternative embodiment of the structure is shown in FIGS. 23-25. In the embodiment of FIGS. 23-25, the bracket 200 is substantially identical to the bracket 200 discussed elsewhere herein. Similarly, the spring 204 is substantially identical to the spring 204 discussed elsewhere herein. In the guard assembly 2305, the guard 2302 is modified from the design of the guard 202 disclosed and discussed elsewhere herein. In the embodiment of FIGS. 23-25, the cavity 2602 differs from the cavity 602 described earlier. The cavity 602 was configured such that the guard 202 extended on both lateral sides of the bracket 200. In the embodiment of FIGS. 23-25, the guard 2302 extends on a first lateral side 2306 of the bracket 200, but not on the second lateral side 2308 of the bracket 200. As may be seen in any of FIGS. 23-25, the entire second lateral side 2308 of the bracket 200 may be visible. In many embodiments, it may be desirable for the fully visible, non-enclosed side 2308 of the bracket 200 to be the side adjacent the nuts 218. This may be desirable because it is more likely for an obstacle to become stuck on a nut 218 than on the head of the fastener 216 because of their shapes.

FIGS. 23-25 illustrate one embodiment of a more planar-style guard 2302. However, the guard 2302 may retain some level of depth and may be considered to incorporate a recess, although one that is somewhat more open. The guard 2302 may incorporate a recess 2602 that may include a first lobe 2404, a second lobe 2406, and a third lobe 2408. The spring 204 may rest against the bottom surface 2648 of the third lobe 2408 of the recess 2602. The lower end 230 of the first leg 206 may be configured to rest against the bottom surface 2650 of the first lobe 2404. The lower end 232 of the second leg 208 may be configured to rest against the bottom surface 2652 of the second lobe 2406.

In the embodiments disclosed, each of the cavities 602, 2602 illustrated includes a bottom segment. In some embodiments, it may be desirable to eliminate additional size and weight and eliminate the bottom portion of the guard adjacent to the lower ends 230, 232 of the legs 206, 208, particularly in addition to exposing one side of the bracket. A configuration lacking a bottom surface is shown in FIG. 26 and described earlier in this specification. A person of ordinary skill in the art is able to combine these features without undue experimentation. In such a configuration, it may be desirable to select a larger washer to ensure appropriate clamping force between the guard and the bracket is adequate to force the bracket, guard, and spring to function as described herein.

As may be seen, the size and shape of the spring 204 in the embodiment of FIGS. 23-25 may be substantially identical to the other embodiments. However, the third lobe 2408 of the cavity 2602 may be configured differently. In many embodiments, such as the one previously described in connection with the guard 202, the third lobe 2408 may extend upwardly on one face 312 of the spring 204 and the opposite face 310 of the spring 204. The use of a cavity that extends upwardly along both faces 310, 312 may be desirable for a variety of reasons, including that enclosing the spring 204 may reduce the probability of the spring 204 becoming dislodged from the assembly when the spring 204 is compressed. However, where weight or size is a primary consideration, or for other reasons well known to persons of ordinary skill in the art, one face 310 of the spring 204 may remain more exposed. A person of ordinary skill in the art will be able to determine a minimum height to which the spring 204 must be enclosed for it to remain safely in place based on the predicted force on the spring 204, the materials selected for the parts, and the like. In some embodiments, it may be desirable to include a supplemental securing structure, such as a fastener that extends through both the guard and the spring (not shown) or a supplemental strap that may attach to both the guard and the spring (not shown) to ensure the spring remains in an appropriate position. A person of ordinary skill in the art may select from whichever of these features he or she believes to be desirable in order to have the guard assembly function as the designer wishes.

Another alternative embodiment is shown in FIG. 27. In the embodiment of FIG. 27, the bracket 200 and the related features and attachment structures may be identical to those features described elsewhere in this specification. Accordingly, where the numbers are the same as earlier embodiments, a person of ordinary skill in the art will understand the parts are substantially identical. In the embodiment of FIG. 27, the configuration of the guard 2702 is modified from the configuration of the guard 202 described elsewhere herein. The guard 2702 may have a first cavity 2708 and a second cavity 2710. The first cavity 2708 may be similar in function to the first lobe 604 of the cavity as shown and described in earlier embodiments. The second cavity 2710 may be similar in function to the second lobe 606 of the cavity as shown and described in earlier embodiments. The first arm 206 of the bracket 200 may be inserted into the first cavity 2708 and the second arm 208 of the bracket 200 may be inserted into the second cavity 2710, rather than into the first lobe 604 and second lobe 606, respectively.

In the embodiment of FIG. 27, the spring may also be differently sized, shaped, and positioned. In the embodiment of FIG. 27, a first spring 2704 may be positioned on a bottom surface 2712 of the first cavity 2708. A second spring 2706 may be positioned on a bottom surface 2714 of the second cavity 2710. In this configuration, the lower end 230 of the first leg 206 may rest against a top surface 2716 of the first spring 2704 in a rest position. In such a configuration, the lower end 230 of the first leg 206 may be a first engagement surface which engages the first spring 2704 in a rest position. Further, the lower end 232 of the second leg 208 may rest against a top surface 2718 of the second spring 2706 in a rest position. In such a configuration, the lower end 232 of the second leg 208 may be a second engagement surface which engages the second spring 2706 in a rest position.

As was described elsewhere herein, the parts, including the fasteners 616 and the related washers and nuts may be assembled together. The configuration of FIG. 27 may allow for a greater variety of compression settings for the first spring 2704 and the second spring 2706. In some embodiments, the initial rest position of the configuration 2705 may be as shown where the engagement surfaces 230, 232 rest against the respective springs 2704, 2706 with the springs 2704, 2706 in an uncompressed position. If desired, the springs 2704, 2706 may also be preloaded by pressing upward on the lower surface 2720 of the guard 2702. This upward pressing may force the springs 2704, 2706 into engagement with the engagement surfaces 230, 232 to at least partially compress the springs 2704, 2706 into a preloaded rest position. Also, where it is desirable, the assembly 2705 may be assembled to function like the configuration shown in FIGS. 21-23 where there is a gap between the engagement surfaces 230, 232 and the springs 2704, 2706. Further, because the springs 2704, 2706 are fit into a recess, the risk of the springs 2704, 2706 becoming dislodged because of encountering a large obstacle is minimized. In this way, the embodiment of FIG. 27 may have additional advantages that will be apparent to a person of ordinary skill in the art without undue experimentation.

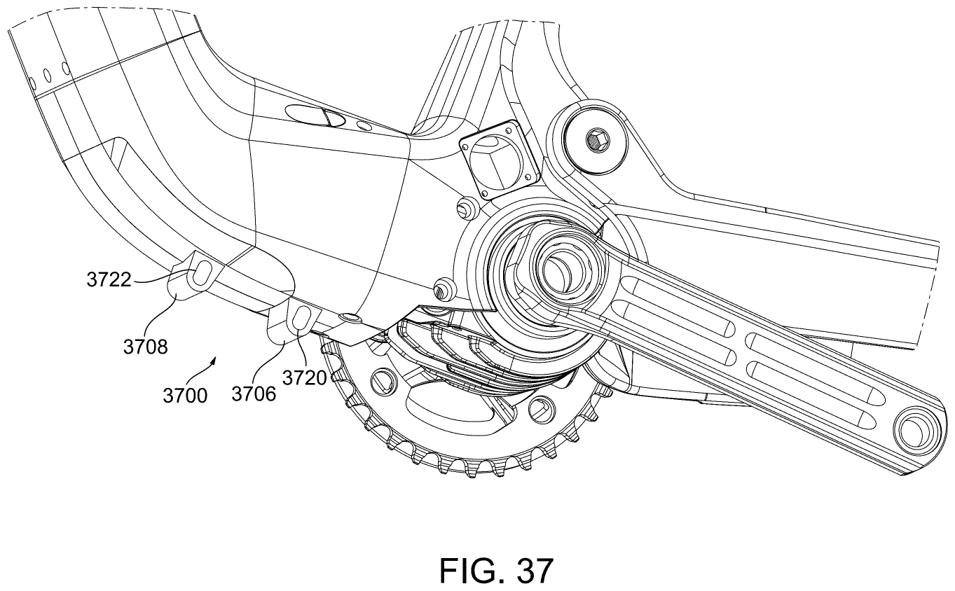

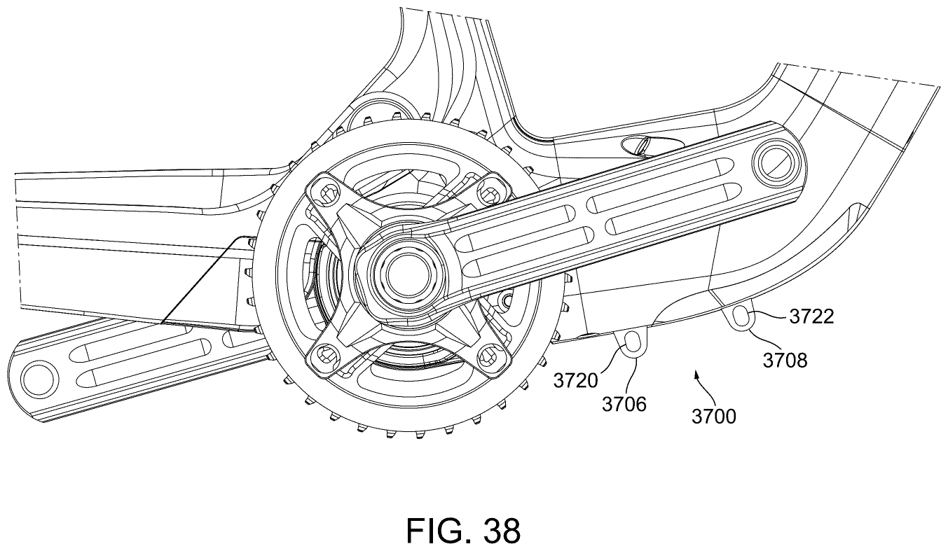

As another exemplary embodiment, the bracket 3700 of FIGS. 37 and 38 may be secured to a bicycle frame, motor or motor mount without the use of bolts. In some embodiments, the bracket 3700 may be secured to the frame by welding or an adhesive. In other embodiments, the bracket 3700 may be secured to the frame using an internal screw not visible in these FIGS., but as would be apparent to a person of ordinary skill in the art. In the embodiment of FIGS. 37 and 38, the bracket 3700 need not be attached to the frame in a particular relationship to a crankshaft, because the bracket 3700 lacks any central aperture to accommodate a crankshaft. Indeed, in the embodiment shown in FIGS. 37-38, the bracket 3700 may include a first arm 3706 and a second arm 3708. The first arm 3706 and the second arm 3708 may be substantially parallel to one another. The first arm 3706 and the second arm 3708 may be attached separately to the frame and not be attached to one another. However, in such an embodiment, the first arm 3706 and the second arm 3708 may be considered together to be one bracket 3700. In this embodiment, the first arm 3706 may include a first slot 3720 and the second arm 3708 may include a second slot 3722. Any of the springs and guards disclosed elsewhere in this disclosure may be used in connection with the bracket 3700 in a manner similar to the other disclosed embodiments. In an embodiment using a bracket like the bracket 3700, the bracket 3700 may omit the engagement surface entirely or in part. In such an embodiment, the sliding of the guard along the slots 3720, 3722 in the arms 3706, 3708 may compress the spring in a manner similar to that disclosed in connection with the other embodiments. However, in using the bracket 3700, the spring may be compressed between the guard and a portion of the bicycle assembly adjacent the first arm 3706 and the second arm 3708. In many embodiments, the spring may be compressed between the guard and a portion of the bicycle assembly between first arm 3706 and the second arm 3708. Similarly to other embodiments, each of the arms 3706, 3708 may be configured to pass into at least one cavity in the guard to allow the compression of the spring.

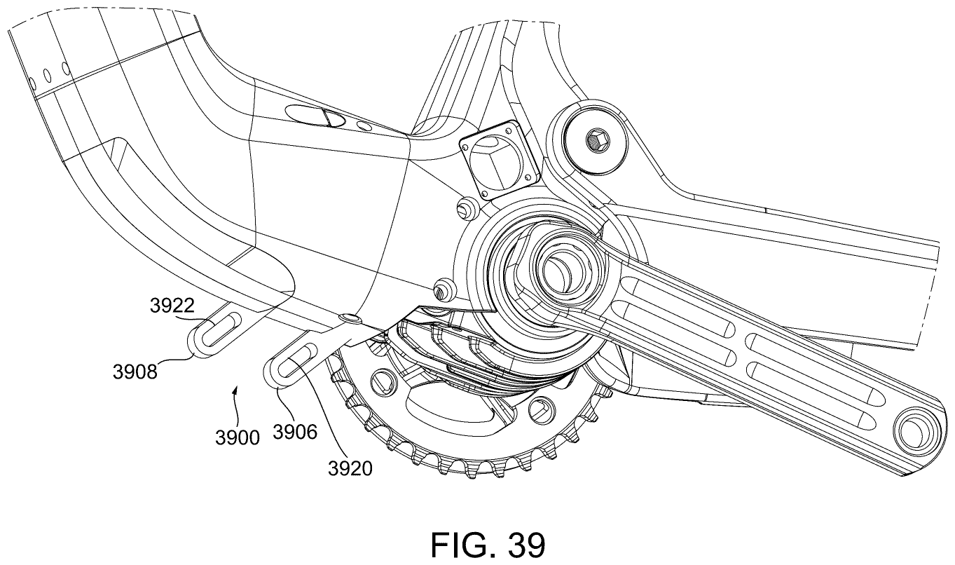

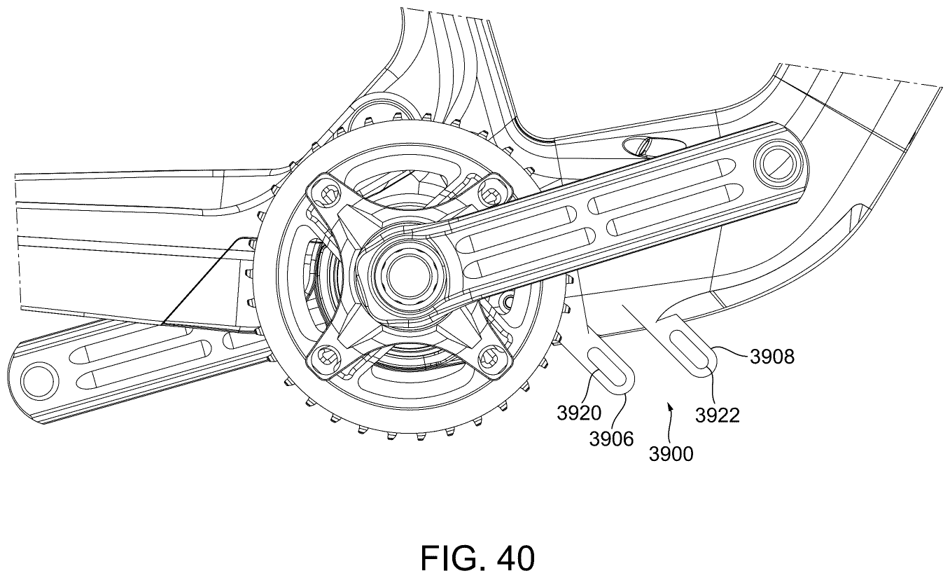

As another exemplary embodiment, the bracket 3900 of FIGS. 39 and 40 may be secured to a bicycle frame, motor or motor mount without the use of bolts. In some embodiments, the bracket 3900 may be secured to the frame by welding or an adhesive. In other embodiments, the bracket 3900 may be secured to the frame using an internal screw not visible in these FIGS., but as would be apparent to a person of ordinary skill in the art. In the embodiment of FIGS. 39 and 40, the bracket 3900 need not be attached to the frame in a particular relationship to a crankshaft, because the bracket 3900 lacks any central aperture to accommodate a crankshaft. Indeed, in the embodiment shown in FIGS. 39-40, the bracket 3900 may include a first arm 3906 and a second arm 3908. The first arm 3906 and the second arm 3908 may be substantially parallel to one another. The first arm 3906 and the second arm 3908 may be attached separately to the frame and not be attached to one another. However, in such an embodiment, the first arm 3906 and the second arm 3908 may be considered together to be one bracket 3900. In this embodiment, the first arm 3906 may include a first slot 3920 and the second arm 3908 may include a second slot 3922. Any of the springs and guards disclosed elsewhere in this disclosure may be used in connection with the bracket 3900 in a manner similar to the other disclosed embodiments. In an embodiment using a bracket like the bracket 3900, the bracket 3900 may omit the engagement surface entirely or in part. In such an embodiment, the sliding of the guard along the slots 3920, 3922 in the arms 3906, 3908 may compress the spring in a manner similar to that disclosed in connection with the other embodiments. However, in using the bracket 3900, the spring may be compressed between the guard and a portion of the bicycle assembly adjacent the first arm 3906 and the second arm 3908. In many embodiments, the spring may be compressed between the guard and a portion of the bicycle assembly between first arm 3906 and the second arm 3908. Similarly to other embodiments, each of the arms 3906, 3908 may be configured to pass into at least one cavity in the guard to allow the compression of the spring.

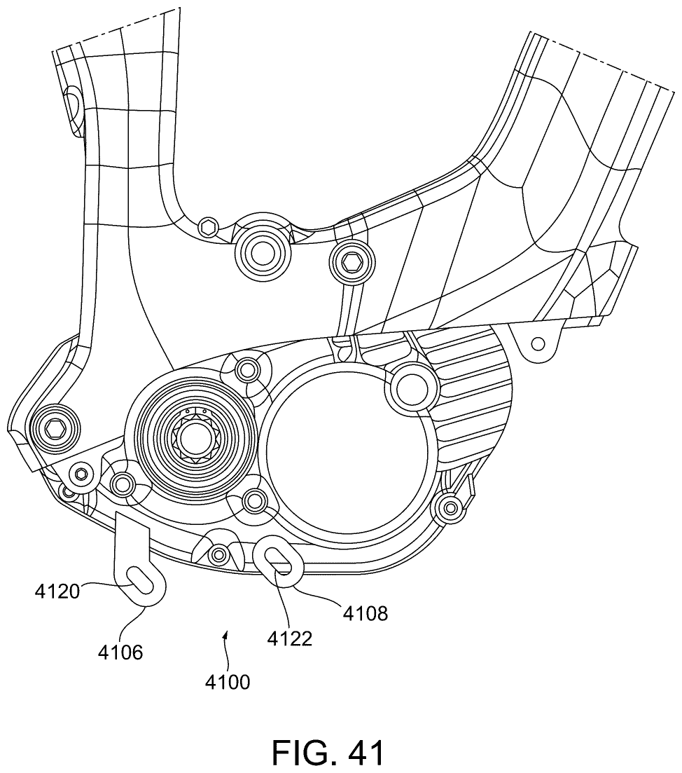

As another exemplary embodiment, the bracket 4100 of FIG. 41 may be secured to a bicycle frame, motor or motor mount without the use of bolts. In some embodiments, the bracket 4100 may be secured to the motor mount by welding or an adhesive. In other embodiments, the bracket 4100 may be secured to the frame using an internal screw not visible in these FIGS., but as would be apparent to a person of ordinary skill in the art. In the embodiment of FIG. 41, the bracket 4100 need not be attached to the frame in a particular relationship to a crankshaft, because the bracket 4100 lacks any central aperture to accommodate a crankshaft. Indeed, in the embodiment shown in FIG. 41, the bracket 4100 may include a first arm 4106 and a second arm 4108. In this embodiment, the first arm 4106 is shown to differ in shape and size from the second arm 4108. In some embodiments, depending on the available clearances between parts of the bicycle assembly, for aesthetic reasons, or for whatever reason may be deemed important by a designer, it may be desirable for the first arm 4106 to differ in shape and size from the second arm 4108. The first arm 4106 and the second arm 4108 may have corresponding portions that are substantially parallel to one another. The first arm 4106 and the second arm 4108 may be attached separately to the frame and not be attached to one another. However, in such an embodiment, the first arm 4106 and the second arm 4108 may be considered together to be one bracket 4100. In this embodiment, the first arm 4106 may include a first slot 4120 and the second arm 4108 may include a second slot 4122. Any of the springs and guards disclosed elsewhere in this disclosure may be used in connection with the bracket 4100 in a manner similar to the other disclosed embodiments. In an embodiment using a bracket like the bracket 4100, the bracket 4100 may omit the engagement surface entirely or in part. In such an embodiment, the sliding of the guard along the slots 4120, 4122 in the arms 4106, 4108 may compress the spring in a manner similar to that disclosed in connection with the other embodiments. However, in using the bracket 4100, the spring may be compressed between the guard and a portion of the bicycle assembly adjacent the first arm 4106 and the second arm 4108. In many embodiments, the spring may be compressed between the guard and a portion of the bicycle assembly between first arm 4106 and the second arm 4108. Similarly to other embodiments, each of the arms 4106, 4108 may be configured to pass into at least one cavity in the guard to allow the compression of the spring.

The present disclosure has included a variety of configurations of the three main portions. Several embodiments were disclosed for the bracket. Several embodiments were disclosed for the spring. Several embodiments were disclosed for the guard. Each of the embodiments of any one particular element may have only been illustrated with a single embodiment of the other elements. A person of ordinary skill in the art is able to select any one embodiment of the bracket, any one embodiment of the spring, and any one embodiment of the guard and use them together without undue experimentation. In any combination of the elements, the assembly may be configured to function in the same way as disclosed in connection with the specifically disclosed combinations without undue experimentation.

This detailed description in connection with the drawings is intended principally as a description of the presently preferred embodiments of the invention and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A guard assembly for protecting a portion of a bicycle assembly, comprising:
a bracket comprising a first arm and an engagement surface adjacent the first arm;
a guard adjustably secured to the bracket and defining a cavity;
a spring having a first side configured to fit against the guard and a second side configured to contact the engagement surface of the bracket and having a rest configuration;
wherein the guard is configured to move relative to the bracket; and
wherein the relative position of the guard and the bracket defines a deformation of the spring from the rest configuration.

2. The guard assembly according to claim 1, wherein the spring defines a slot and the slot contacts the engagement surface.

3. The guard assembly according to claim 1, wherein the cavity has at least three lobes.

4. The guard assembly according to claim 3, wherein at least a portion of each of the spring and the first arm of the bracket are configured to pass into the cavity.

5. The guard assembly according to claim 1, wherein the bracket comprises a second arm.

6. The guard assembly according to claim 5, wherein the first arm is attached to the guard by a first fastener and the second arm is attached to the guard by a second fastener.

7. The guard assembly according to claim 1, wherein the guard moves substantially linearly relative to the bracket.

8. A guard assembly for protecting a portion of a bicycle assembly, comprising:
a bracket comprising a first arm defining a first slot;
a guard defining a first aperture;
a fastener configured to pass through the first aperture and the first slot to secure the guard to the bracket adjustably along the first slot;
a spring having a first side configured to be in direct contact with the bracket and a second side in contact with the guard.

9. The guard assembly according to claim 8, wherein the bracket comprises a second arm defining a second slot.

10. The guard assembly according to claim 8, wherein the guard is configured to move linearly relative to the bracket.

11. The guard assembly according to claim 8, wherein the guard is configured to move rotationally relative to the bracket.

12. The guard assembly according to claim 8, wherein the spring is configured to fit within a spring cavity defined in one of the guard and the bracket.

13. The guard assembly according to claim 8, wherein the first side of the spring defines a slot.

14. The guard assembly according to claim 8, wherein the spring is adjacent the first arm.

15. A guard assembly for protecting a portion of a bicycle assembly, comprising:
a bracket having at least one arm;
a guard defining a cavity; and
a spring;
wherein the bracket and the guard are attached to one another by a fastener;
wherein the bracket and the guard are configured to move relative to one another by compressing the spring; and
wherein the at least one arm is configured to move within the cavity.

16. The guard assembly according to claim 15, wherein the cavity has a bottom surface and a free end of the at least one arm is capable of contacting the bottom surface.

17. The guard assembly according to claim 16, wherein the spring contacts the bottom surface.

18. The guard assembly according to claim 15, wherein the spring is formed from a resilient material.

19. The guard assembly according to claim 15, wherein the spring defines a slot, and the slot contacts the bracket.

20. The guard assembly according to claim 15, wherein the spring is spaced from the at least one arm.
